(19) United States
(12) Patent Application Publication
(10) Pub. No.: US 2018/0111136 A1
(43) Pub. Date: Apr. 26, 2018

(54) PART CIRCLE MECHANISM FOR IMPACT SPRINKLER

(71) Applicant: Naandanjain Irrigation Ltd., Kibbutz Naan (IL)

(72) Inventors: Lior Eliahu Mareli, Rehovot (IL); Eli Armon, Even Yehuda (IL)

(73) Assignee: Naandanjain Irrigation Ltd., Kibbutz Naan (IL)

(21) Appl. No.: 15/569,865

(22) PCT Filed: Jan. 28, 2016
(86) PCT No.: PCT/IL2016/050099

§ 371 Date: Oct. 27, 2017

(30) Foreign Application Priority Data
Apr. 28, 2015 (IL) 238501

(51) Int. Cl. B05B 3/16; B05B 3/06

(52) U.S. Cl. CPC B05B 3/16; B05B 3/063

(57) ABSTRACT

Disclosed is a part circle mechanism assembly mounted on a sprinkler. The part circle mechanism assembly comprises a base with a symmetrical rotational structure. The symmetrical structure further comprises a plurality of contact faces. Further a lower trip is mounted on the base. The part circle mechanism assembly further comprises an upper trip mounted on the base. At least two sector rings are mounted on the sprinkler. At least one sector ring from the at least two sector rings is in contact with the lower trip. Further the part circle mechanism assembly comprises a trip spring mounted on both trips—upper and lower. The trip spring is configured to actuate the upper trip to reverse a motion of the sprinkler. Further a cover is configured to snap fit on the base.

### TECHNICAL FIELD

The present subject matter described herein, in general, relates to part circular mechanism, and more particularly to part circular mechanism assembly for an impact sprinkler.

### BACKGROUND

Impact sprinklers use hammer and circular action to deliver water and nutrients to the crops in the field. Further few of the impact sprinklers are configured to reverse their circular motion upon actuation mechanism like part circle mechanism.

However, the present actuator mechanism lack retrofit ability on existing impact sprinkler, or do not perform optimally under all the circumstances like variation in pressure.

### SUMMARY

This summary is provided to introduce aspects related to a part circle mechanism assembly and the aspects are further described below in the detailed description. This summary is not intended to identify essential features of the claimed subject matter nor is it intended for use in determining or limiting the scope of the claimed subject matter.

In one implementation, a part circle mechanism assembly is disclosed. The part circle assembly may comprise a base. The base may further have a lower trip mounted upon the base. An upper trip may further be mounted on the base. The part circle mechanism assembly may further comprise a trip spring. The trip spring may be mounted on the lower trip and the upper trip. Further the part circle mechanism assembly may comprise a cover. The cover can be snap fitted over the base.

In another implementation of the present disclosure a part circle mechanism assembly mounted on a sprinkler is disclosed. The part circle mechanism assembly may comprise a base with a symmetrical rotational structure. The symmetrical rotational structure may comprise a plurality of contact faces. Further a lower trip may be mounted on the base. The part circle mechanism assembly may further comprise an upper trip mounted on the base. Further at least two sector rings mounted on the sprinkler. At least one sector ring from the at least two sector rings may be in contact with the lower trip. Further the part circle mechanism assembly may comprise a trip spring mounted on the lower trip and the upper trip. The trip spring may be configured to reverse a motion of the sprinkler. Further a cover is configured to snap fit on the base.

In yet another implementation of the present disclosure a method for operating a part circle mechanism assembly is disclosed. The method may comprise engaging a bottom arm of a lower trip with a first sector ring from at least two sector rings. Further rotating the lower trip about an axis of a base to a first position. The method may further comprise simultaneously compressing a trip spring connecting the lower trip and an upper trip. Further method may comprise retaining the trip spring to a mean position, wherein the trip spring in turn moves the upper trip. The method may further comprise engaging an engaging surface of the upper trip with a rear portion of the hammer. Further engaging the bottom arm with a second sector ring from the at least two sector rings. The method may expand the trip spring while moving the lower trip to a second position. Further retaining the trip spring to the mean position and disengage the upper trip engaging surface from the hammer.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1, illustrates a part circle mechanism assembly, in accordance with present disclosure.

FIG. 2, illustrates a base in accordance with the present subject matter.

FIG. 3, illustrates a lower trip in accordance with the present disclosure.

FIG. 4 illustrates an upper trip in accordance with the present disclosure.

FIG. 5, illustrates a cross-section of part circle mechanism assembly according to an exemplary embodiment of the present disclosure.

FIG. 6, illustrates a complete assembly in accordance with the present disclosure.

FIG. 7, illustrates a working example in accordance with an embodiment.

### DETAILED DESCRIPTION

The present subject matter discloses a part circle mechanism for an impact sprinkler.

The present subject matter discloses a part circular mechanism assembly designed to work on exiting impact sprinkler. The part circular mechanism assembly may be designed to operate with all nozzles and pressure range of the sprinkler. Further presence of an arc surface on an upper trip, enables the part circular mechanism assembly to operate within the smallest nozzle (2.3 mm) and the lowest operating defined pressure of 0.8 Bar. Further the upper trip and a lower trip may have integral stoppers that operate interactively with a bayonet base/base with a symmetrical rotational structure.

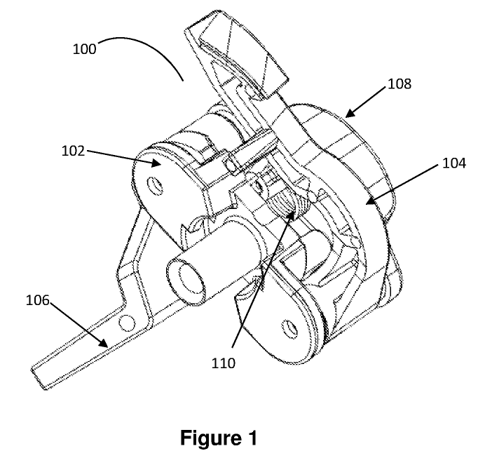

Referring to FIG. 1, illustrates a part circle mechanism assembly, in accordance with present disclosure. The part circle mechanism assembly 100, may comprise a base 102. The base 102 can be defined as a bayonet base. Further part circle mechanism assembly 100 may comprise a lower trip 106, mounted on the base 100. Further an upper trip 104 as illustrated may be mounted on the base 102. A trip spring 110, may be jointly mounted on the lower trip 106 and upper trip 104. The trip spring may be configured to change or reverse direction of the sprinkler. In an exemplary embodiment the trip spring 110 may act as an actuator for the upper trip 104 configured to reverse the direction of sprinkler when the spring force is overcomed. The part circle mechanism assembly 100 may comprise a cover 108. The cover 108 can be snap fitted over the base 102, and covering the trip spring 110.

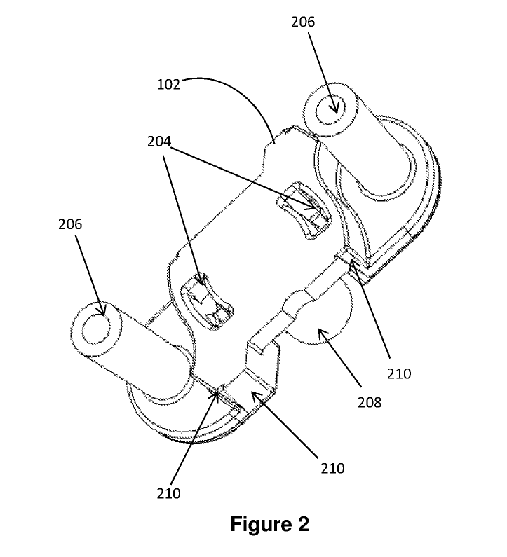

Referring to FIG. 2, illustrates a base in accordance with the present subject matter. The base 102, may have a symmetrical rotational structure along an axis of rotation. The base 102 may comprise a recession 204. The recession 204 may be configured to accommodate the connection to the sprinkler. The base 102, may further comprise a plurality of first cylindrical protrusion 206. The plurality of first cylindrical protrusion 206, may be configured to receive a cover for snap fit. In an exemplary embodiment the plurality of first cylindrical protrusion 206, are adapted to receive a lower trip, an upper trip, wherein the lower trip and the upper trip have hollow cylindrical recess to be able to fit on the first cylindrical protrusion 206. Further the cover can be mounted after mounting the lower trip and upper trip in snap fit format thus locking the assembly in a fixed position without the use of external fasteners.

Further a second cylindrical protrusion 208 may be fabricated integrally with the base 102. The second cylindrical protrusion 208, may be adapted to mount on a sprinkler. The base 102 may further comprise a plurality of contact faces 210. The plurality of contact faces 210 are distributed across the base 102. The plurality of contact faces 210 may be configured to perform or act as a stopper integrally provided by way of fabrication/manufacture of the base 102.

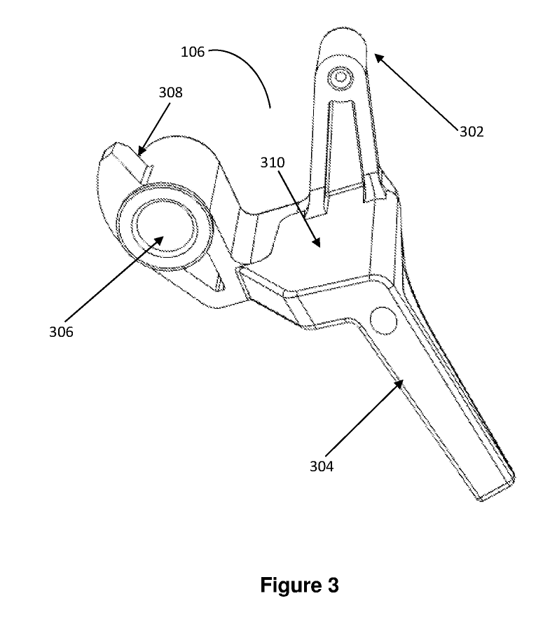

FIG. 3, illustrates a lower trip in accordance with the present disclosure. The lower trip 106, may comprise a third cylindrical protrusion 302. The third protrusion 302, may be configured to receive one end of the trip spring. The one end of the trip spring may be press fitted. Further the lower trip 106 may comprise a lower arm 304. The lower trip 106 may further comprise a first hollow cylindrical recess 306. The first hollow cylindrical recess 306 may be fixed on the base. The hollow cylindrical structure enables the first hollow cylindrical recess 306 to rotate about its axis.

The lower trip 106 may further comprise a first contact face 308. The first contact face 308 may perform as an integral first top stopper. Further a second contact surface 310 may act as an integral first bottom stopper.

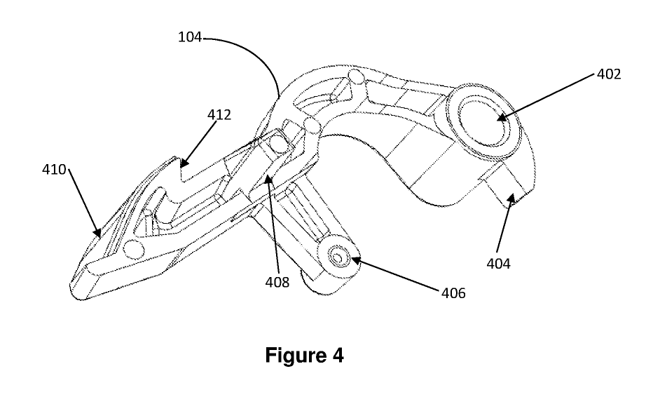

Referring to FIG. 4 illustrates an upper trip in accordance with the present disclosure. The upper trip 104, a second hollow cylindrical recess 402. The upper trip 104 may be fitted or mounted on the base by aligning the second hollow cylindrical recess 402 with plurality of first cylindrical protrusion on the base. The second hollow cylindrical recess 402 may be adapted to rotate about its axis. The rotation about its axis may enable the engagement of a first surface 410 with a hammer of the sprinkler. The first surface can further enable the hammer to glide upon the upper trip 104 and overcome spring force of the trip spring by forcing downward movement to the upper trip 104 and enable reverse the motion at pre-defined set of conditions. The upper trip may further comprise an engaging surface 412. The engaging surface 412 may engage with an engagement surface positioned on the hammer.

The upper trip 104 may further comprise a fourth cylindrical protrusion 406. The fourth cylindrical protrusion 406, may be configured to accommodate another end of the trip spring. Further a third contact surface 404 may be configured to perform as an integral second bottom stopper upon contacting the plurality of contact faces of the base. The upper trip 104 may further comprise a fourth contact surface 408 may be configured to perform as an integral second top stopper. The integral second top stopper acts as a stopper upon contacting the plurality of contact faces of the base.

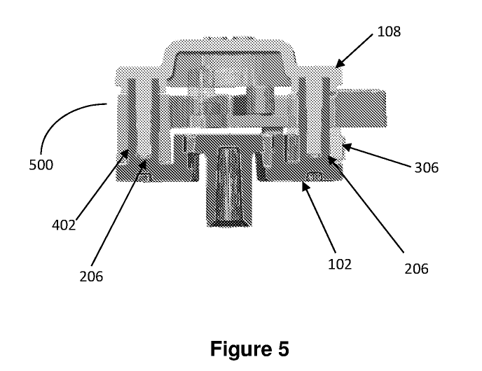

FIG. 5, illustrates a cross-section of part circle mechanism assembly according to an exemplary embodiment of the present disclosure. The cross-section 500 according an exemplary embodiment illustrates the assembly of part circle mechanism. The cross-section 500 shows the cover 108 snap fitted over the base 102. The snap fit of the cover 108 may provide protection and fastening means to components assembled on the base 102. For e.g. the second hollow cylindrical recess 402 of the upper trip is accommodated in the plurality of the plurality of first cylindrical protrusion 206, similarly the first hollow cylindrical recess 306 of the lower trip is accommodated in the plurality of the plurality of first cylindrical protrusion 206. The plurality of first cylindrical protrusion 206 enable the second hollow cylindrical recess 402 and the first hollow cylindrical recess 306 to rotate about the axis.

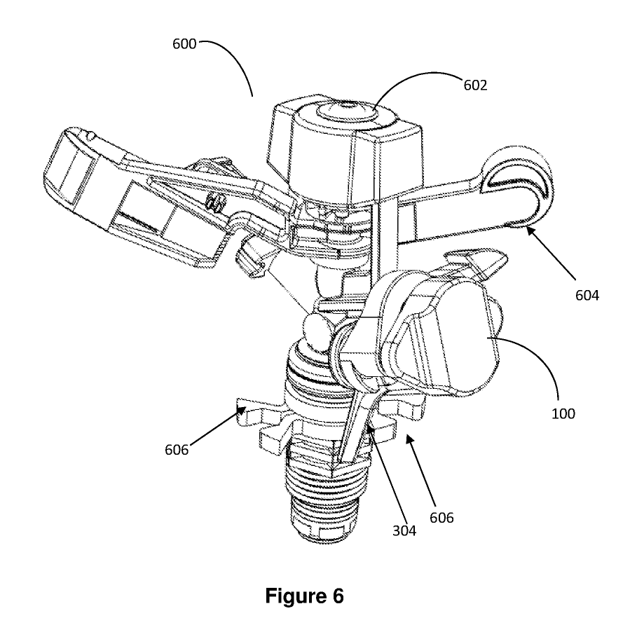

Now referring to FIG. 6, illustrates a complete assembly in accordance with the present disclosure. The complete assembly 600 comprises a sprinkler 602. The sprinkler may further comprise hammer 604. The hammer 604 may be mounted on an axis of the sprinkler in the conventional way. The hammer 604 may impart the impact motion to the sprinkler 602. Further the sprinkler 602 may have the part circle mechanism assembly 100 mounted on the sprinkler 602. The upper trip from the part circle mechanism assembly 100 interacts with the hammer 604 to change the motion of the sprinkler. Further a plurality of sector ring 606 mounted on the sprinkler 602. In an exemplary embodiment at least two sector rings 606 can be mounted on the sprinkler 602. The at least two sector ring 606 i.e. a first sector ring and a second sector ring can be mounted at pre-defined angle between them. The at least two sector ring may further comprise of a first protruding surface and a second protruding surface. The first protruding surface on the first sector ring may be at a pre-defined first angle with the second protruding surface on the second sector ring. Further a lower arm 304 of the lower trip may be in contact with either the first protruding surface or the second protruding surface.

### WORKING EXAMPLE

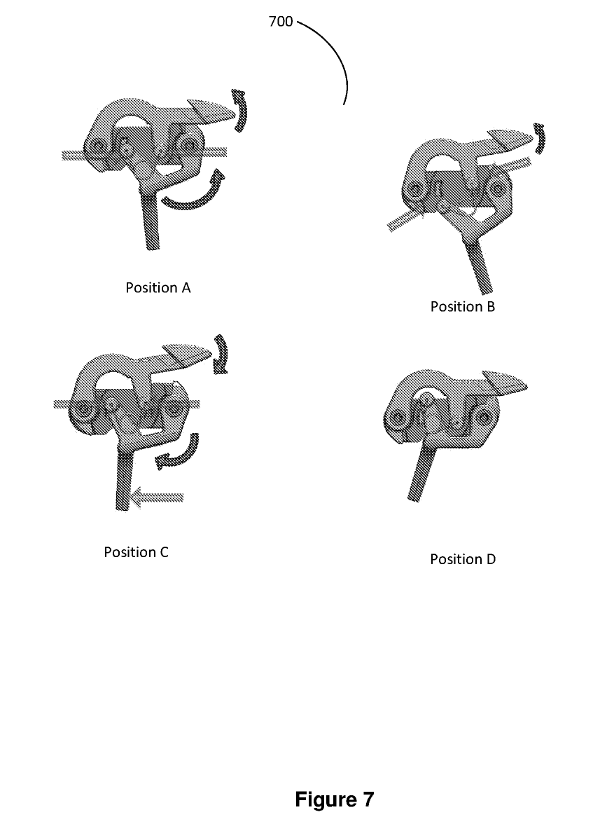

Referring to FIG. 7, illustrates a working example in accordance with an embodiment. According to the exemplary embodiment 700, the operation of the part mechanism (PCM) assembly, i.e. engagement and disengagement with a sprinkler can be illustrated using 4 different positions of a lower trip and upper trip of the part mechanism assembly. According to the exemplary embodiment the PCM can be separated into an activated mode and a deactivated mode. In the deactivated mode the PCM assembly may not be in contact or engaged with a hammer of the sprinkler. Thereby allowing the hammer to oscillate freely about a sprinkler axis. Further, when the PCM is mounted on the sprinkler along with at least two sector rings, the PCM may engage or disengage with the hammer, based on the position of the lower trip and upper trip. According to the exemplary embodiment the sprinkler rotates until a bottom arm of the lower trip engages with a first sector ring from the at least two sector ring. The PCM activation step may occur when the lower trip is starting to rotate about its axis of the base. The lower trip movement will stop until the upper stopper of the lower trip engage the base as shown by Position B. At position A simultaneously compression of a trip spring connecting the lower trip and an upper trip is shown. Further to retain the trip spring to a mean position, the trip spring in turn moves the upper trip. At position C the bottom arm may be engaged with a second sector ring from the at least two sector rings, thereby expanding the trip spring while moving the lower trip to a second position. At position D the trip spring is retained to the mean position thereby disengaging the engaging surface of the upper trip from the hammer. The engagement of the upper trip from a rear of the hammer allow the reversal of the direction and subsequent disengagement disallow the reversal of the direction.

We claim:

1. A part circle mechanism assembly, comprising:
a base including a plurality of contact faces;
a lower trip mounted on the base;
an upper trip mounted on the base;
a trip spring mounted on the lower trip and the upper trip; and
a cover configured to snap fit on the base.

2. (canceled)

3. The part circle mechanism assembly of claim 1, further comprising a sprinkler and wherein the part circle mechanism assembly is mounted on the sprinkler.

4. The part circle mechanism assembly of claim 3, further comprising a hammer mounted on an axis of the sprinkler.

5. (canceled)

6. The part circle mechanism assembly of claim 3, further comprising a plurality of sector rings mounted on the sprinkler, wherein at least one sector ring from the plurality of sector rings is frequently in contact with the lower trip.

7. The part circle mechanism assembly of claim 4, wherein the upper trip comprises a first surface, wherein the first surface enables the hammer to glide upon and overcome the spring force of the trip spring.

8. The part circle mechanism assembly of claim 1, wherein the lower trip further comprises a first contact face configured to perform as an integral first top stopper.

9. The part circle mechanism assembly of claim 8, wherein the lower trip further comprises a second contact face configured to perform as an integral first bottom.

10. The part circle mechanism assembly of claim 9, wherein the upper trip comprises a third contact face configured to perform as an integral second bottom.

11. The part circle mechanism assembly of claim 10, wherein the upper trip further comprises a fourth contact face configured to perform as an integral second stopper.

12. A part circle mechanism assembly mounted on a sprinkler, comprising:
a base, wherein the base comprises a plurality of contact faces;
a lower trip mounted on the base;
an upper trip mounted on the base;
at least two sector rings mounted on the sprinkler, wherein at least one sector ring from the at least two sector rings is frequently in contact with the lower trip;
a trip spring mounted on the lower trip and the upper trip, wherein the trip spring is configured to trigger the upper trip due to movement of the lower trip and reverse a motion of the sprinkler; and
a cover configured to snap fit on the base.

13. (canceled)

14. The part circle mechanism of claim 12, further comprising a hammer mounted on an axis of the sprinkler.

15. The part circle mechanism for the sprinkler of claim 12, wherein the at least two sector rings comprises a first sector ring and a second sector ring.

16. The part circle mechanism for the sprinkler of claim 15, wherein:
the first sector ring comprises a first protruding surface; and
the second sector ring comprises a second protruding surface.

17. The part circle mechanism for the sprinkler of claim 16, wherein the first protruding surface and the second protruding surface have a pre-defined first angle.

18. The part circle mechanism for a sprinkler of claim 14, wherein the upper trip comprises a first surface, wherein the first surface enables the hammer to glide upon and overcome spring force of the trip spring.

19. The part circle mechanism for the sprinkler of claim 12, wherein a first contact face on the lower trip is configured to perform as an integral first top stopper upon contacting at least one of the plurality of contact faces of the base.

20. The part circle mechanism for the sprinkler of claim 19, wherein a second contact face on the lower trip is configured to perform as an integral first bottom stopper upon contacting at least f the plurality of contact faces of the base.

21. The part circle mechanism for the sprinkler of claim 20, wherein a third contact face on the upper trip is configured to perform as an integral second bottom stopper upon contacting at least one of the plurality of contact faces of the base.

22. The part circle mechanism for the sprinkler of claim 21, wherein a fourth contact face on the upper trip is configured to perform as an integral second top stopper upon contacting at least one of the plurality of contact faces of the base.

23. A method for operating a part circle mechanism assembly, the method comprising:
engaging a bottom arm of a lower trip with a first sector ring from at least two sector ring;
rotating the lower trip about an axis of a base to a first position; simultaneously compressing a trip spring connecting the lower trip and an upper trip;
retaining the trip spring to a mean position, wherein the trip spring in turn moves the upper trip;
engaging an engaging surface of the upper trip with a hammer; engaging the bottom arm with a second sector ring from the at least two sector ring;
expanding the trip spring while moving the lower trip to a second position; and retaining the trip spring to the mean position and disengage the engaging surface from the hammer.
